(19) United States
(12) Patent Application Publication
(10) Pub. No.: US 2012/0246612 A1
(43) Pub. Date: Sep. 27, 2012

(54) SYSTEM AND METHOD FOR VERIFICATION AND VALIDATION OF REDUNDANCY SOFTWARE IN PLC SYSTEMS

(75) Inventors: Kun Ji, Plainsboro, NJ (US); Zhen Song, Plainsboro, NJ (US)

(73) Assignee: Siemens Corporation, Iselin, NJ (US)

(21) Appl. No.: 13/415,897

(22) Filed: Mar. 9, 2012

Related U.S. Application Data
(60) Provisional application No. 61/466,650, filed on Mar. 23, 2011.

(51) Int. Cl. G06F 9/44

(52) U.S. Cl. 717/104

(57) ABSTRACT

Formal methods are instituted to verify and validate the finite state machine (FSM) of PLC redundancy software. The method and system is implemented through each phase in the lifecycle of the redundancy software; that is, the requirement phase, design phase, implementation phase and, finally, integration phase (including system integration). At each step along the way, the verification and validation process uses tools such as a checklist-based review and inspection, a requirement traceability analysis, formal verification (model checking) and the like to ensure that the created redundancy software is error-free and will perform as intended when implemented in the redundant PLC system.

### CROSS-REFERENCE TO RELATED APPLICATION

This application claims the benefit of US Provisional Application No. 61/466,650, filed Mar. 23, 2011 and herein incorporated by reference.

### TECHNICAL FIELD

The present invention relates to redundant PLC systems and, more particularly, to a verification and validation process and system for providing objective assessment of the complete lifecycle of the redundancy software associated with these systems.

### BACKGROUND OF THE INVENTION

Programmable logic controllers (PLCs) are considered as a special type of computer used in automation systems. Generally speaking, PLCs are based on sensors and actuators, which have the ability to control, monitor and interact with a particular process or collection of processes. PLCs are highly configurable and thus can be applied to various industrial sectors such as, for example, automotive, chemical, energy, transportation and the like.

In some situations, a redundant PLC architecture is utilized, as shown in FIG. 1. In this arrangement a first PLC 10 and a second PLC 20 are both communicating with various external devices via a network 30. The external devices are illustrated as I/O modules 40, 42 and 44 in this example, which are known to interface with various sensors, actuators, power supply units and the like (not shown). PLC 10 is designated as the “master” PLC, which would then be operational and communicating with the external devices during normal operating conditions. PLC 20 is designated as the “standby” PLC, which comes on line to communicate with the various external devices upon error/failure of PLC 10. The conventional operations associated with controlling actuators, reading inputs from sensors, etc. is defined by “PLC function” module 12 in PLC 10 (and module 22 in PLC 20).

As also shown in FIG. 1, PLC controller redundancy functionality is provided by redundancy management component 14 in PLC 10 and component 24 in PLC 20, with these components being loosely coupled to each other. As further shown, each redundancy management component further comprises a finite state machine (FSM), with FSM 16 in PLC 10 and FSM 26 in PLC 20. FSM 16 is utilized to monitor the state of PLC 10 and manage the switchover to PLC 20 when necessary (FSM 26 works in a similar fashion to manage the switch back to master PLC 10). In particular, each finite state machine permits only one of the two redundant PLCs to be an “active” PLC at any point in time. Redundancy management components 14 and 24 are therefore essential to the proper operation of a “failsafe” redundant system.

A problem with this arrangement, however, is that in most practical utilizations, the total state space of an FSM (such as FSM 16) is too big for exhaustive testing (the “state space” being the combination of all possible states). In some cases, test scripts are employed that probe a subset of the state space, the various test scenarios chosen to satisfy various requirements. U.S. Pat. No. 7,024,589 entitled “Reducing the Complexity of Finite State Machine Test Generation Using Combinatorial Designs” and issued to A. Hartman et al. on Apr. 4, 2006 discloses this type of testing arrangement, albeit for a system other than redundancy software. While plausible to provide a certain degree of assurance, without an exhaustive test of every possible state, the system cannot be completely verified. Redundancy manager 14 utilizes an extremely complicated FSM 16 and exhaustive testing of FSM 16 is considered to be impractical, if not impossible.

Indeed for complicated FSM configurations, exhaustive testing (either manual or automatic) is not an option. Even if a sophisticated testing system were to be available, it remains prohibitive to exhaustively test all possible conditions. As a result of the large state space (that is, all possible combinations of different states), exhaustive texting on a complex FSM may require, in theory, thousands of years. Formal verification tools, such as a model checker, are currently used to intelligently select a small set of representative states for testing, but have not been fully utilized in arrangements such as the redundancy software of a PLC system.

Thus, a need remains for an automated system for verifying and validating, prior to implementation, the redundancy software requirement of a PLC system.

### SUMMARY OF THE INVENTION

The needs remaining in the prior art are addressed by the present invention, which relates to redundant PLC systems and, more particularly, to a verification and validation process and system for providing objective assessment of the complete lifecycle of the redundancy software associated with these systems.

In accordance with the present invention, formal methods are instituted to verify and validate the finite state machine (FSM) of the PLC redundancy software. The method and system is implemented through each phase in the lifecycle of the redundancy software; that is, the requirement phase, design phase, implementation phase and, finally, integration phase (including system integration). At each step along the way, the verification and validation process uses tools such as a checklist-based review and inspection, a requirement traceability analysis, formal verification (model checking) and the like to ensure that the created redundancy software is error-free and will perform as intended when implemented in the redundant PLC system.

In one embodiment, the present invention relates to a computer readable medium including programming instructions for performing verification and validation of redundancy software for a programmable logic control (PLC) system, including programming instructions for: (1) processing PLC redundancy requirements to create a feature specification, including a comparison of the PLC redundancy requirements and the created feature specification to verify and validate that all redundancy requirements are properly represented in the feature specification; (2) processing the feature specification to generate a related architecture specification of software components capable of performing the defined features and a detailed design document of each software component, including a comparison of the feature specification and the architecture specification and detailed design documents to verify and validate that all features are properly represented in the architecture specification and associated detailed design documents; (3) capturing a finite state machine design from the detailed design documents and verifying the finite state machine design; (4) creating source code modules from the detailed design documents, wherein each source code module is tested to perform verification and validation; and (5) integrating the verified and validated source code modules with the redundancy component of the PLC system, including performing verification and validation of the operation of the source code modules in the PLC system.

In another embodiment, the present invention defines a method, implemented in a computer, for validating and verifying a redundancy software development for a programmable logic control (PLC) system, and including the steps of: (1) processing PLC redundancy requirements to create a feature specification, including a comparison of the PLC redundancy requirements and the created feature specification to verify and validate that all redundancy requirements are properly represented in the feature specification; (2) processing the feature specification to generate a related architecture specification of software components capable of performing the defined features and a detailed design document of each software component, including a comparison of the feature specification and the architecture specification and detailed design documents to verify and validate that all features are properly represented in the architecture specification and associated detailed design documents; (3) capturing a finite state machine design from the detailed design documents and verifying the finite state machine design; (4) creating source code modules from the detailed design documents, wherein each source code module is tested to perform verification and validation; and (5) integrating the verified and validated source code modules with the redundancy component of the PLC system, including performing verification and validation of the operation of the source code modules in the PLC system.

Other and further aspects and features of the present invention will become apparent during the course of the following discussion and by reference to the accompanying drawings.

### BRIEF DESCRIPTION OF THE DRAWINGS

Referring now to the drawings,

FIG. 1 contains an architectural diagram of an exemplary redundant PLC system that may utilize the verification and validation methodology of the present invention in the analysis of the redundancy manager and associated finite state machine (FSM);

FIG. 2 is an overview diagram of an exemplary verification and validation process for PLC redundancy software in accordance with the present invention;

FIG. 3 contains a detailed diagram of the requirements phase verification and validation component of the present invention;

FIG. 4 contains a detailed diagram of the design phase verification and validation component of the present invention;

FIG. 5 contains a detailed diagram of the implementation phase verification and validation component of the present invention; and

FIG. 6 contains a detailed diagram of the integration phase verification and validation component of the present invention.

### DETAILED DESCRIPTION

The redundancy management software of a Programmable Logic Controller (PLC) utilizes a finite state machine (FSM) to monitor and manage the system redundancy functionality. Previously, test and simulation approaches have been used evaluate the redundancy software. However, as noted above, these approaches yield incomplete results and do not probe into every possible combination of states in the complete state space of the finite state machine (FSM). The focus of this work is on formal verification and validation of the complete state space of the FSM.

Indeed, the present invention provides a verification and validation process (and associated software-based tools) to provide objective assessment of the redundant PLC system throughout the entire lifecycle of the redundancy software (requirements, design, implementation and integration). As described in detail below, formal methods (including, for example, model checking, traceability and the like) are used to verify the FSM of the PLC redundancy software.

As discussed above, the redundancy management software of a PLC utilizes a FSM to monitor and manage the system redundancy functionality. PLC redundancy-related software faults need to be identified at the time of software compilation, and the redundancy features need to be verified and validated to meet the safety requirements associated with the redundancy—an especially important aspect for PLCs involved in safety-critical applications such as railway train control, energy system control, and the like.

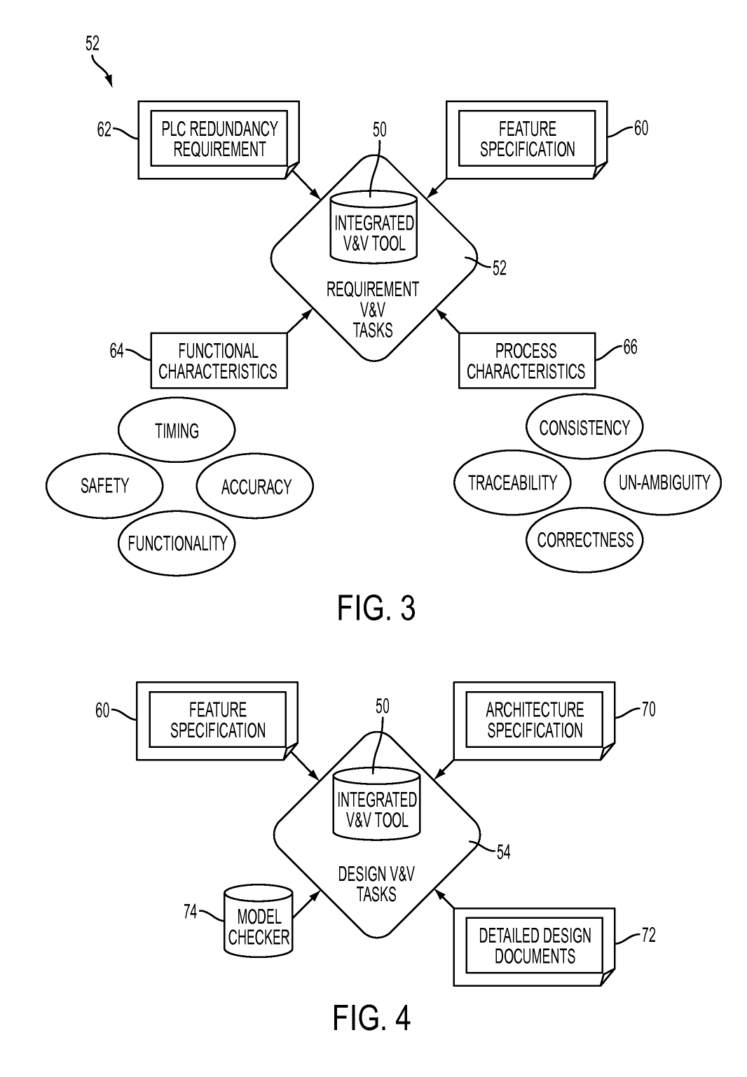

FIG. 2 is a high level diagram illustrating the architecture of the overall verification and validation methodology of the present invention. In particular, set of verification and validation tools 50 is proposed in accordance with the present invention that interacts with the redundancy software through each phase of its lifecycle. In particular, tools 50 are first used to verify and validate a set of initial requirements for providing PLC redundancy within a FSM, defined as “requirements phase 52” and described in detail below in association with the diagram of FIG. 3. Following the conclusion of requirements phase 52, verification and validation tools 50 are used to analyze a developed system architecture (and specific modules) during a design phase 54 (discussed in detail in association with the diagram of FIG. 4).

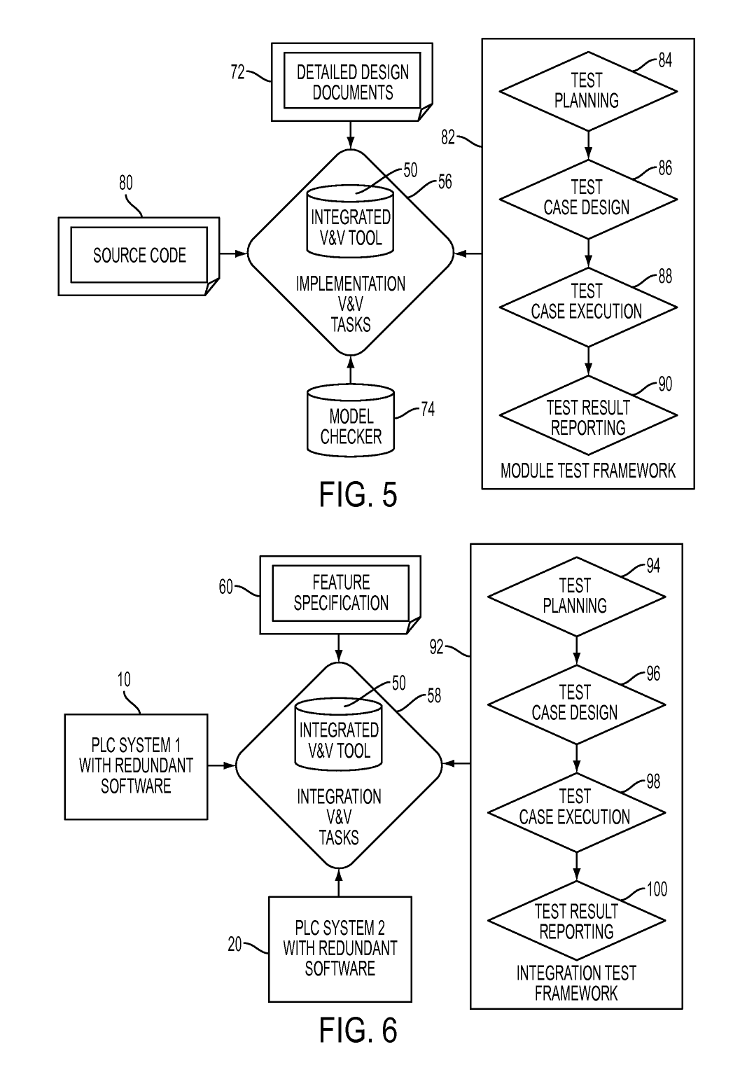

An implementation phase 56 is associated with generating the specific source code for the detailed design created in the previous phase, with the verification and validation used to perform testing of each software module (see FIG. 5). Lastly, verification and validation tools 50 of the present invention are utilized during an implementation phase 58 to analyze the performance of both the redundancy software and the complete PLC system, where FIG. 6 illustrates the details of the verification and validation process for implementation phase 58.

Referring now to FIG. 3, requirements phase 52 is shown in detail as using tool 50 to perform tasks that can be divided into two separate categories: “functional” and “process”. The output from requirements phase 52 is a high-level feature specification 60 that summarizes all of the requirements associated with PLC redundancy performance for a specific application, as defined in an initial set of PLC redundancy requirements 62. It is to be noted that each specific PLC system may embody a set of different PLC redundancy requirements, so feature specification 60 is considered as a unique process; the verification and validation process of the present invention is intended to be sufficiently robust and flexible to perform the required analysis on each created feature specification.

Referring to the details of FIG. 3, the verification and validation tasks of tool 50 during requirements phase 52 are shown as including the responsibilities of: (1) verifying that each specific functional requirement mentioned in requirements 62 is indeed included within high-level feature specification 60 and (2) validating the process characteristics associated therewith.

As shown, an exemplary set of functional characteristics 64 to be verified by tool 50 include the timing, accuracy, safety and functionality of the set of initial requirements as embodied in requirements listing 62. A set of process characteristics 66 to be validated is seen to include consistency, traceability, unambiguity and correctness. In accordance with the present invention, verification and validation tool 50 is used to perform a traceability analysis between requirements listing 62 and feature specification 60, as well as a checklist-based review and inspection to validate the processes embodied in feature specification 60 against the original requirements within listing 62. The verification and validation operations are continued to be performed during requirements phase 52 until all conditions are satisfied and feature specification 60 is fully verified and validated with respect to the initial requirements listing 62.

At this point, the process moves into design phase 54, as shown in FIG. 4. The specific design is based upon feature specification 60, with the end product being an architecture specification 70 and specific detailed design documents 72 for each software component. Architecture specification 70 is the basic design document that provides the architectural overview of all of the software components and defining the specific interactions these software components have with each other. Design documents 72 include the details of each software component forming architecture specification 70.

Verification and validation tool 50 is used during design phase 54 to verify that all of the requirements listed in feature specification 60 are included in architecture specification 70 and to validate the detailed design of each component within design documents 72. In particular, tool 50 utilizes a traceability task to cross-check between feature specification 60 and architecture specification 70, verifying the inclusion of each feature in the design. A conventional model checker component 74 is used by tool 50 to verify the specifics of each detailed design document 72.

During implementation phase 56, as shown in FIG. 5, detailed design documents 72 are used to generate the associated source code 80. Verification and validation tool 50 is used at this stage in the process to test each generated source code module, with an exemplary flow 82 of module testing shown in FIG. 5 as including the steps of test planning 84, test case design 86, test case execution 88 and test result reporting 90. Model checker 74 is also used at this stage. It is to be understood that software module will continue to be tested and checked until its performance is without error. Indeed, the overall verification and validation process for the PLC redundancy software will not progress into the final integration phase 58 until each software module is verified and validated.

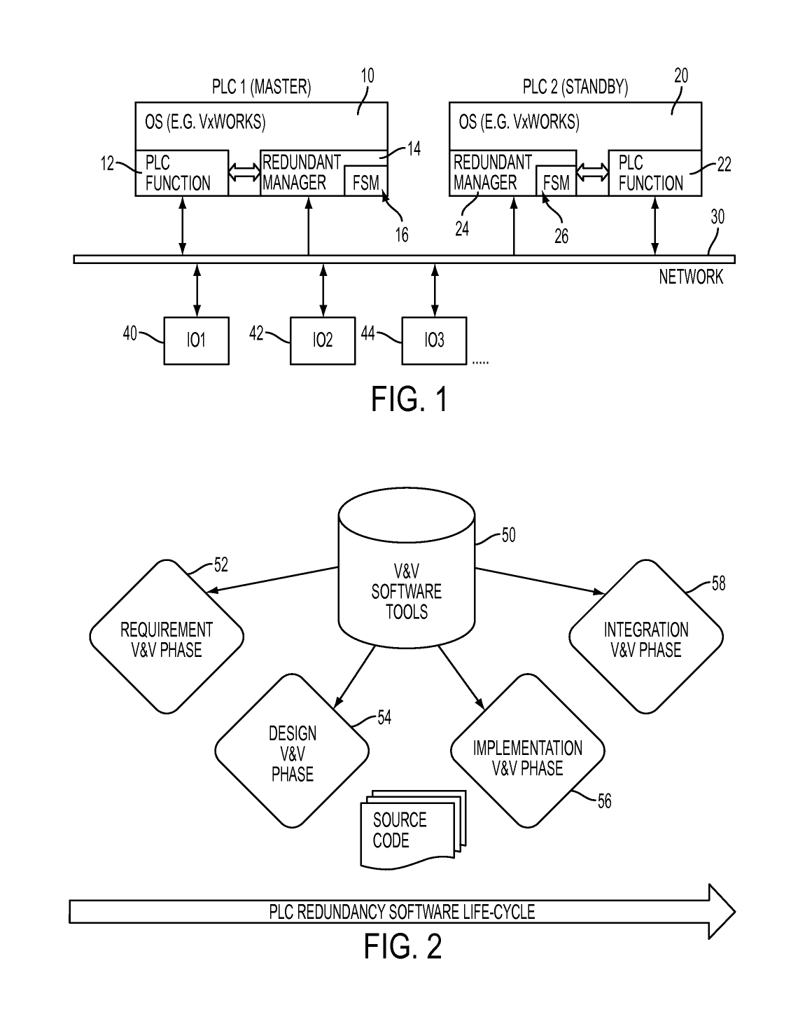

The verification and validation tasks included within integration phase 58 are divided into two categories: a software integration task (i.e., integration testing on the redundant software component) and a system integration task (i.e., integration testing on the overall PLC system including the redundant software component). As with the testing at implementation phase 56, software integration verification utilizes an exemplary integration test framework 92 which includes test planning 94, test case design 96, test case execution 98 and test result reporting 100. For integration testing of the overall PLC system, an actual setup such as shown in FIG. 1 is used to test all of the features.

In summary, the present invention proposes a verification and validation process (and associated software tools) for providing objective assessment of the redundant PLC system throughout the entire lifecycle of redundancy software development (from defining initial requires to final implementation in a redundant PLC system). As described in detail above, formal methods such as model checking are used to verify the FSM of the PLC redundancy software and ensure its proper operation as installed in a working system.

The specific software tools as utilized in accordance with the present invention may be launched from a computer-readable medium in a computer-based system to execute the various functions discussed above (in particular, the detailed functionalities as shown in FIGS. 2-6). Programs embodying the invention or portions thereof may be stored on a variety of types of computer readable media, including optical disks, hard disk drives, tapes, programmable read-only memory (ROM) chips and the like.

While the preferred and other embodiments of the present invention have been illustrated and described, it will be clear that the invention is not so limited. Numerous modifications, changes, variations, substitutions and equivalents will occur to those of ordinary skill in the art without departing from the spirit and scope of the present invention as defined by the following claims.

What is claimed is:

1. A computer readable medium including programming instructions for performing verification and validation of redundancy software for a programmable logic control (PLC) system, comprising programming instructions for:
processing PLC redundancy requirements to create a feature specification, including a comparison of the PLC redundancy requirements and the created feature specification to verify and validate that all redundancy requirements are properly represented in the feature specification;
processing the feature specification to generate a related architecture specification of software components capable of performing the defined features and a detailed design document of each software component, including a comparison of the feature specification and the architecture specification and detailed design documents to verify and validate that all features are properly represented in the architecture specification and associated detailed design documents;
capturing a finite state machine design from the detailed design documents and verifying the finite state machine design;
creating source code modules from the detailed design documents, wherein each source code module is tested to perform verification and validation; and
integrating the verified and validated source code modules with the redundancy component of the PLC system, including performing verification and validation of the operation of the source code modules in the PLC system.

2. The computer readable medium according to claim 1 wherein the programming instructions for processing PLC redundancy requirements includes verifying functional characteristics of the created features in the feature specification and validating process characteristics of the created features in the feature specification.

3. The computer readable medium according to claim 2 wherein the functional characteristics are selected from the group consisting of: timing, accuracy, safety and functionality.

4. The computer readable medium according to claim 2 wherein the process characteristics are selected from the group consisting of: consistency, traceability, unambiguity and correctness.

5. The computer readable medium according to claim 1 wherein the programming instructions for processing the feature specification to generate the related architecture specification of software components includes a model checker for verifying and validating the operation of each software component.

6. The computer readable medium according to claim 1 wherein the programming instructions for creating source code modules from the detailed design documents utilizes a model checker and a source code module test framework to perform verification and validation.

7. The computer readable medium according to claim 6 wherein the source code module test framework includes programming instructions for test planning, test case design, test case execution and test result reporting.

8. The computer readable medium according to claim 1 wherein the programming instructions for integrating the verified and validated source code modules with the redundancy component of the PLC system includes using the feature specification to verify that all desired features are correctly implemented and tested.

9. The computer readable medium according to claim 8 wherein the programming instructions perform integration testing with the feature specification by test planning, test case design, test case execution and test result reporting.

10. A method, implemented in a computer, for validating and verifying a redundancy software development for a programmable logic control (PLC) system, the method comprising the steps of:
processing PLC redundancy requirements to create a feature specification, including a comparison of the PLC redundancy requirements and the created feature specification to verify and validate that all redundancy requirements are properly represented in the feature specification;
processing the feature specification to generate a related architecture specification of software components capable of performing the defined features and a detailed design document of each software component, including a comparison of the feature specification and the architecture specification and detailed design documents to verify and validate that all features are properly represented in the architecture specification and associated detailed design documents;
capturing a finite state machine design from the detailed design documents and verifying the finite state machine design;
creating source code modules from the detailed design documents, wherein each source code module is tested to perform verification and validation; and
integrating the verified and validated source code modules with the redundancy component of the PLC system, including performing verification and validation of the operation of the source code modules in the PLC system.

11. The method according to claim 10 wherein the step of processing PLC redundancy requirements includes the further steps of:
verifying functional characteristics of the created features in the feature specification; and
validating process characteristics of the created features in the feature specification.

12. The method according to claim 11 wherein the functional characteristics are selected from the group consisting of: timing, accuracy, safety and functionality.

13. The method according to claim 1 wherein the process characteristics are selected from the group consisting of: consistency, traceability, unambiguity and correctness.

14. The method according to claim 10 wherein the step of processing the feature specification to generate the related architecture specification of software components includes the step of utilizing a model checker for verify and validate the operation of each software component.

15. The method according to claim 10 wherein the step of creating source code modules from the detailed design documents includes utilizing a model checker and a test framework with each source code module to perform verification and validation.

16. The method according to claim 15 wherein the step of utilizing a test framework includes programming instructions for test planning, test case design, test case execution and test result reporting.

17. The method according to claim 10 wherein the step of integrating the verified and validated source code modules with the redundancy component of the PLC system includes the step of using the feature specification to verify that all desired features are correctly implemented and tested.

18. The method according to claim 17 wherein the programming instructions perform integration testing with the feature specification by test planning, test case design, test case execution and test result reporting.
